(19) United States
(12) Patent Application Publication
(10) Pub. No.: US 2001/0041047 A1
(43) Pub. Date: Nov. 15, 2001

(54) Data recording device, performance recording system using the same, and recording medium storing data recording program

(76) Inventor: Momoe Kawajiri, Osaka (JP)

Correspondence Address: BIRCH STEWART KOLASCH & BIRCH, PO BOX 747, FALLS CHURCH, VA, 22040-0747, US

(21) Appl. No.: 09/852,001

(22) Filed: May 10, 2001

(30) Foreign Application Priority Data
May 10, 2000 (JP) 2000-137722
Apr. 27, 2001 (JP) 2001-133575

(51) Int. Cl. H04N 5/76; H04N 7/00

(52) U.S. Cl. 386/46; 386/83

(57) ABSTRACT

A user carries with him/her a portable device having the form of an entrance ticket, etc., to a performance site so that the portable device stores an identifier of the performance, or uses an information processing device to receive via a broadcasting system or network record data of the performance held at the performance site transmitted from a broadcast station or server as required with the corresponding identifier attached. When an identifier extracted from the received data coincides with an identifier from the portable device, the information processing device stores record data corresponding to the identifier together with the identifier. To reproduce the record data, it is checked whether the same identifier as that from the portable device is stored in the information processing device. When storing the same identifier, record data corresponding to it is read out for reproduction, thereby obtaining lively memories based on actual, pleasant experience related to the performance and readily obtaining an accurate record of performance contents.

### FIELD OF THE INVENTION

The present invention relates to a data recording device capable of recording contents of a performance that the user has actually watched, on a later date, a performance recording system using the same, and a recording medium that stores a program for recording data.

### BACKGROUND OF THE INVENTION

Generally, baseball games, theatrical performances, etc., are enjoyed by actually going to the sites of performances, such as baseball stadiums, theaters, etc., to watch the games or performances, or by watching the performances broadcasted on TV, for example, without actually going to the sites. If the performances are watched at the sites, live performances can be enjoyed at the sites and can be vividly kept in memories. In the case of a broadcast as well, though inferior to the case of watching performances at sites since lacking in the feeling of liveliness, performance contents can still be appreciated. If not recorded, however, memories of the performance contents fade, thereby gradually vanishing.

Therefore, to recollect the entertainment later, it is necessary to record the performances at the sites by means of cameras, video cameras, etc., or to record broadcasts of the foregoing performances (record images, sounds, and the like).

An attempt to keep an accurate record of a performance at a performance site, however, requires concentration on the recording activities, thereby making it impossible to enjoy the performance and to keep vivid memories. Besides, a point of view for recording is fixed to that where the user of a camera, a video camera, or the like is seated at the performance site, and it is substantially impossible to record the performance from various angles at different points of view.

On the other hand, in the case of recording a broadcast, it is indeed possible to keep an accurate record from various angles, whereas it is difficult to record an entirety of the performance due to a limit of the broadcast time. Even if its entirety is broadcast during night time at discount rate of electricity, it is still necessary to consciously check through the time table so as to program recording. Besides, a broadcast cannot leave the watcher such vivid memories as being at a live performance.

### SUMMARY OF THE INVENTION

An object of the present invention is to provide a data recording device by which a user can obtain lively memories from actual, pleasant experience related to a performance while readily obtaining an accurate record of performance contents.

In order to attain the foregoing object, a data recording device according to the present invention includes: receiving means for receiving data distributed through a distribution medium; comparing means for making a comparison between a data identifier included in the data received by the receiving means and a data identifier inputted from the outside; and storing means for storing data having the data identifier when the two data identifiers coincide with each other.

With this arrangement, when, for example, data is the record data of a performance, the data is received by the receiving means of the data recording device via the distribution medium, while allowing a user to input a data identifier corresponding to the performance to the data recording device. The user, for example, obtains the data identifier at a performance site and inputs it to the data recording device. In the data recording device, the comparing means compare data identifiers, and when the two data identifiers coincide with each other, data having the data identifier are stored by the storing means.

By thus selecting data corresponding to the inputted data identifier from the distributed data and storing them, it is possible to store data related to a performance which the user watched at a performance site, where the performance is specified by a data identifier corresponding to the performance. For example, when the data are record data of performance contents in the forms of motion pictures, freeze-frame pictures, sounds, and the like, the user can watch the performance and also stores record data of the performance contents by the storing means.

In order to attain the foregoing object, a performance recording system according to the present invention includes: a portable device superior in carryability for obtaining and storing a data identifier given to a performance at a performance site; a distribution medium (a broadcasting system or network, for example) for distributing record data of the performance as data together with the data identifier; and either of the data recording devices having the foregoing arrangement in which record data are stored based on a data identifier from the portable device and a data identifier from the distribution medium.

In the performance recording system, when, for example, the portable device is made up of an IC card and the like so as to also serve as an entrance ticket for the day of performance, the user can carry with him/her back home the portable device storing at least a data identifier given to the performance of that day so as to offer the data identifier to the data recording device. On the other hand, a record of the performance is distributed as data via a distribution medium such as the broadcasting system or network, in correspondence with the data identifier for the performance stored in the portable device.

In the data recording device, when the data identifier from the portable device coincides with a data identifier included in the distributed data, the accurate record data of the performance corresponding to the data identifier are stored.

By thus selecting data corresponding to the inputted data identifier from the distributed data and storing them, it is possible to store data related to a performance which the user watched at a performance site, where the performance is specified by a data identifier corresponding to the performance, thereby allowing the user to actually watch the performance and also storing record data of performance contents by the data recording device. Consequently, the user can enjoy the actual performance without being troubling by recording operation, while readily obtaining the accurate record of performance contents.

In order to attain the foregoing object, a recording medium according to the present invention stores a data recording program for performing the processes of: making a comparison between a data identifier included in data which are received through a distribution medium and a data identifier inputted from the outside; and storing data having the data identifier when the two data identifiers coincide with each other.

Even in data recording performed by this program, as with the data recording by the foregoing data recording device, data corresponding to the inputted data identifier are selectively stored, thereby enabling the user to record data related to a performance which the user actually watched at a performance site, where the performance is specified by a data identifier corresponding to the performance, thereby allowing the user to actually watch the performance and also storing record data of performance contents according to the storing process. Consequently, the user can enjoy the actual performance without being troubled by recording operation and also readily obtaining the accurate record of the performance contents.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram showing an arrangement of a performance recording system according to a First Embodiment of the present invention.

FIG. 2 is a block diagram showing an arrangement of a portable device in the performance recording system.

FIG. 3 is a block diagram showing an arrangement of an information processing device in the performance recording system.

FIG. 4 is an explanatory view showing a format of data received from a broadcasting system or a network in the performance recording system.

FIG. 5 is a flowchart showing procedures for storing and reproducing record data by the information processing device and procedures for storing record data by an information processing device of a performance recording system according to a Second Embodiment of the present invention.

FIG. 6 is a block diagram showing an arrangement of the performance recording system according to the Second Embodiment of the present invention.

FIG. 7 is a block diagram showing an arrangement of a portable device of the performance recording system shown in FIG. 6.

FIG. 8 is an explanatory view showing a format of data received from a broadcasting system or a network in the performance recording system shown in FIG. 6.

FIG. 9 is a block diagram showing an arrangement of an information processing device of the performance recording system shown in FIG. 6.

FIG. 10 is a flowchart showing procedures for reproducing record data by the information processing device of FIG. 8.

FIG. 11 is a block diagram showing an arrangement of a performance recording system according to a Third Embodiment of the present invention.

FIG. 12 is a block diagram showing an arrangement of an information processing device of the performance recording system shown in FIG. 11.

FIG. 13 is a block diagram showing another arrangement of the information processing device of the performance recording system shown in FIG. 11.

FIG. 14 is a block diagram showing an arrangement of a portable device in the performance recording system according to a Fourth Embodiment of the present invention.

### DESCRIPTION OF THE PREFERRED EMBODIMENTS

[First Embodiment]

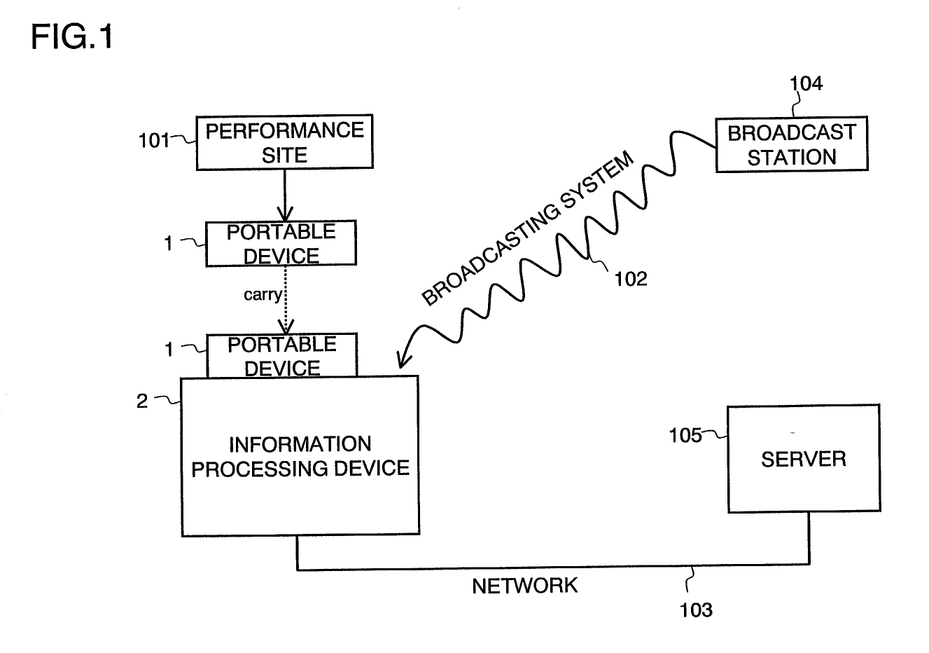

The following will describe one embodiment of the present invention with reference to FIGS. 1 through 5.

As shown in FIG. 1, a performance recording system in accordance with the present embodiment includes a portable device 1, an information processing device 2, a performance site 101, and a broadcasting system 102 or a network 103.

The portable device 1 is a device that a user who is to enjoy an event such as a sport game like a baseball game, or a theatrical performance can carry with him or her when going to a performance site 101 where the event is held. The portable device 1 is arranged so as to receive and store an identifier (data identifier) of the performance supplied from the performance site 101, and to transmit the identifier to the information processing device 2. Preferably adopted as the portable device 1 is a device such as a portable terminal or a mobile phone, and insofar as magnetic recording (storing) of the identifier or the like is available, it may be of a card type, like a ticket, which can be made more compact. The card-type portable device 1 is formed with an IC card or the like that has a function to store an identifier, as described above.

The portable device 1 has, though not shown, a connector with the information processing device 2 so that the portable device 1 be connectable with the information processing device 2. The connection may be realized by, for instance, (i) connecting the portable device 1 via cable with the information processing device 2 disposed on a desk of a common house, (ii) inserting the portable device 1 itself into a loading slot or the like of the information processing device 2, or (iii) wireless communications from the portable device 1 to the information processing device 2.

The information processing device 2 as a data recording device is arranged so as to compare an identifier transmitted from the portable device 1 with an identifier transmitted from the broadcasting system 102 or the network 103; when the foregoing two identifiers match each other, the information processing device 2 extracts and displays record data of the performance provided with correspondence to the identifier. The information processing device 2 is composed of, for instance, a typical personal computer, television image receptor, or the like.

The performance site 101 is a venue, such as a baseball stadium or a theater where a baseball game or a theatrical performance is held, and issues an identifier corresponding to the performance. The identifier is, for instance, transmitted in the form of electric waves in the case where the portable device 1 is a mobile phone, or magnetically or electronically written at an entrance gate when the portable device 1 is a card-type entrance ticket.

The broadcasting system 102 as a distribution medium is a broadcasting system that broadcasts, by wired or wireless communication, record data of a performance supplied from a broadcast station 104 in a format such that the information processing device 2 can receive, and it includes base stations and relay stations. The broadcast station 104 pairs the record data of performance contents supplied from the performance site 101 and an identifier for identification of the record data, and transmits the pair.

The network 103 as distribution medium is a data transmitting system such as the Internet which transmits the record data of a performance supplied from a server 105 to the information processing device 2, in a format such that the information processing device 2 can receive the data, and the network 103 includes a DNS (Domain Name System) and the like. The server 105 pairs record data of performance contents supplied from the performance site 101 and an identifier for identification of the record data, and stores the pair, so as to transmit the pair in response to a request from the information processing device 2.

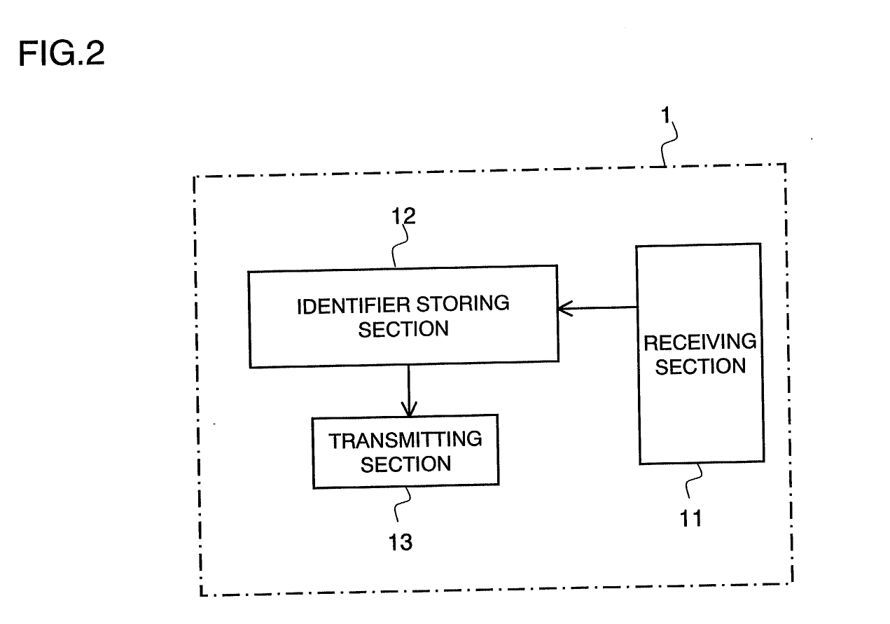

The following will describe the foregoing portable device 1 in detail. As shown in FIG. 2, the portable device 1 includes a receiving section 11, an identifier storing section 12, and a transmitting section 13.

The receiving section 11 receives an identifier of a performance that is sent from the performance site 101. The receiving section 11 includes an antenna, a receiving circuit and the like in the case the identifier is transmitted in the form of electric waves and the like, or alternatively includes an interface for electronically receiving the identifier in the case where the identifier is electronically transmitted, or further alternatively includes an element or the like to which the identifier can magnetically be written when the identifier is magnetically recorded. An identifier of the performance is individually determined for each performance, and functions as a key necessary for later obtaining accurate record data from the broadcasting system 4 or the network 5.

The identifier storing section 12 is composed of a semiconductor memory such as a RAM or the like, and other memory elements and memory devices, to store the identifier received by the receiving section 11. Furthermore, the identifier storing section 12 may be arranged so as to be fixed in the portable device 1, or alternatively arranged so as to be detachable with respect to the portable device 1, like a compact flash memory. In the case where the identifier storing section 12 is thus arranged, it is possible to transmit the identifier to the information processing device 2 even in the case where not the portable device 1 but the identifier storing section 12 is connected to the information processing device 2. Therefore, the information processing device 2 is not necessarily equipped with a connector dedicated for connection with the portable device 1, but only has to be equipped with a connector that provides connection with a common detachable memory. Thus, the information processing device 2 arranged as above is advantageous since being generally applicable.

The transmitting section 13 transmits an identifier stored in the identifier storing section 12 to the information processing device 2 when the portable device 1 is connected with the information processing device 2. The transmitting section 13 carries out transmission when an identifier receiving section 21 of the information processing device 2, which will be described later, is confirmed to be ready to receive an identifier.

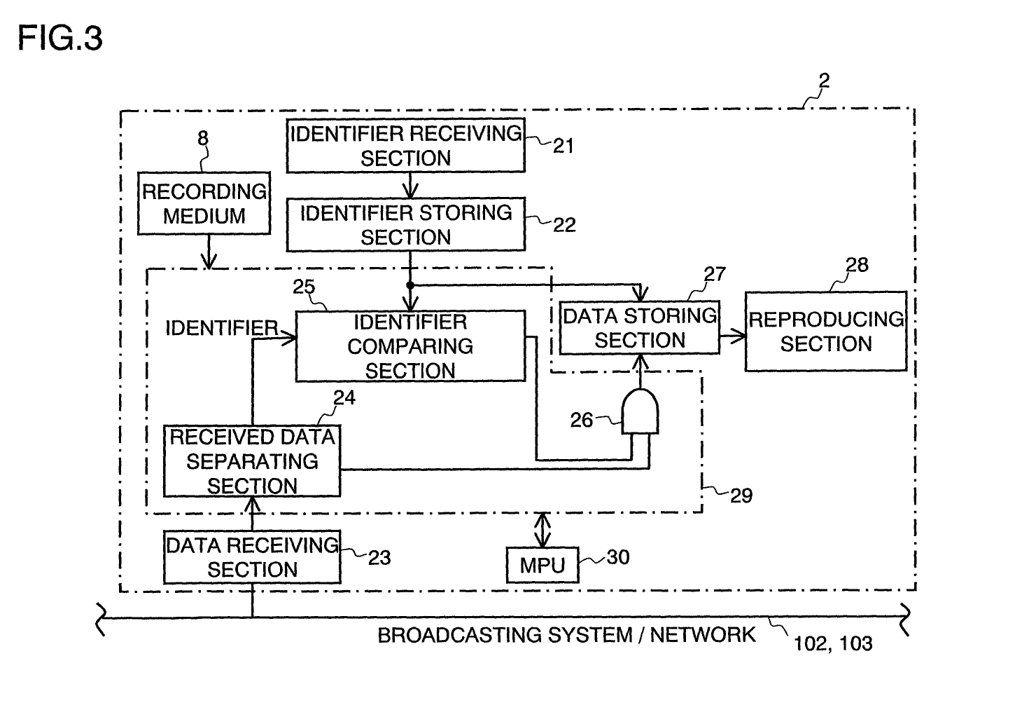

Further, the following will describe the aforementioned information processing device 2 in detail. As shown in FIG. 3, the information processing device 2 is equipped with an identifier receiving section 21, an identifier storing section 22, a data receiving section 23, a received data separating section 24, an identifier comparing section 25, a record data outputting section 26, a data storing section 27, and a reproducing section 28.

The identifier receiving section 21 as receiving means, in a state in which the portable device 1 is communicably connected with the information processing device 2, receives an identifier that has been read out of the aforementioned identifier storing section 12 of the portable device 1 and transmitted from the transmitting section 13. The identifier receiving section 21 is arranged so as to realize the aforementioned connection with the portable device 1.

The identifier storing section 22 is, like the aforementioned identifier storing section 12, composed of a semiconductor memory such as a RAM or the like, and bother memory elements and memory devices, to store the identifier received by the identifier receiving section 21. The identifier storing section 22 reads and outputs an identifier to the identifier comparing section 25 and the data storing section 27.

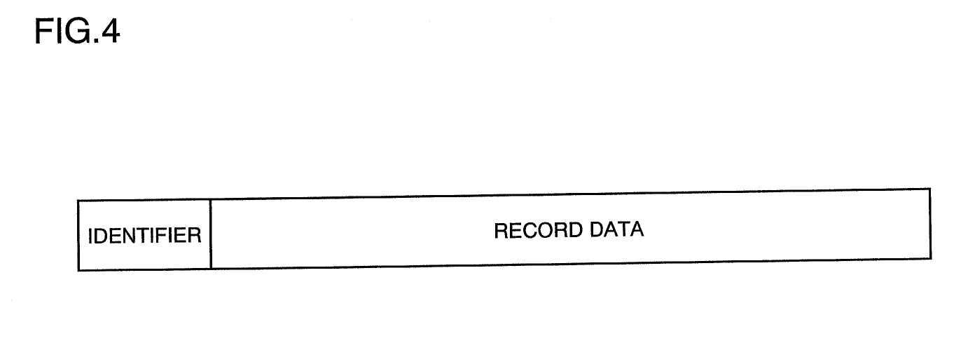

The data receiving section 23 as receiving means receives accurate data permanently transmitted from the broadcasting system 102 or the network 103. Therefore, the data receiving section 23 includes a tuner or the like for broadcasting, and a modem or the like for network communication. As shown in FIG. 4, the foregoing data are transmitted in a state of combination of an identifier and a main body of record data of a performance.

The received data separating section 24 extracts the identifier out of the combination of the record data and the identifier. Besides, the received data separating section 24 separates the record data from the received data and sends the same to the record data outputting section 26.

The identifier comparing section 25 as comparing means compares an identifier separated out by the received data separating section 24, with an identifier read out of the identifier storing section 22. The identifier comparing section 25 outputs, for instance, “1” if they match each other, whereas outputs “0” if they do not match each other. Further, the identifier comparing section 25 checks whether or not record data corresponding to an identifier supplied from the identifier storing section 22 are stored in the data storing section 27. In the case where the record data are already stored therein, the identifier comparing section 25 instructs the data storing section 27 to read the record data corresponding to the identifier. On the other hand, in the case where storage of the same is not confirmed, the identifier comparing section 25 carries out the aforementioned comparing operation.

The record data outputting section 26 outputs, to the data storing section 27, record data separated by the received data separating section 24 corresponding to “1” only when the “1” is inputted from the identifier comparing section 25.

The data storing section 27 as memory means stores the identifier supplied from the identifier storing section 22 and the record data main body supplied from the record data outputting section 26, along with correspondence therebetween, in a table form. Therefore, no record data are stored as to an identifier corresponding to record data that are not outputted to the data storing section 27 via the record data outputting section 26.

The reproducing section 28 as data reproducing means reproduces record data read out of the data storing section 27. The record data are typically sounds, images (motion pictures, freeze-frame pictures, etc.) and the like, or may be combination of images and sounds. Therefore, to provide reproduction of these record data, the reproducing section 28 includes a display device such as a plate-type display panel (liquid crystal panel, EL panel, etc.) or a CRT, and a reproducing device for reproducing sounds (reproducing circuit, amplifying circuit, speaker, etc.).

A record data extracting section 29 that is composed of the received data separating section 24, the identifier comparing section 25, and the record data outputting section 26 so as to extract desired record data is preferably realized with a program that can be provided in a program medium fashion as package software, that is installed in the information processing device 2 by a recording medium 8 that is separable from the information processing device 2. The foregoing program may be installed in the information processing device 2 beforehand as required, for instance, at shipment of the information processing device 2.

The foregoing program is executed by a microprocessing unit 30.

Here, the foregoing program medium may be a medium that fixedly carries a program, examples of which include: those of a tape type such as a magnetic tape and a cassette tape; those of a magnetic disk type such as a floppy disk and a hard disk; those of an optical disk type such as a CD-ROM, an MO, an MD, and a DVD; those of a card type such as an IC card (including a memory card) or an optical card; and semiconductor memories such as a mask ROM, an EPROM, an EEPROM, and a flash ROM.

Furthermore, since the information processing device 2 is a system arranged so as to be connectable with the network 103 including Internet, the recording medium 8 may be a medium that dynamically carries a program so as to download a program from the network 103. In the case where, however, a program is downloaded from the network 103, a program for the downloading operation may be stored in the information processing device 2 beforehand, or may be installed from another recording medium.

To record a performance using the performance recording system thus arranged, first of all, a user carrying the portable device 1 goes to the performance site 101, where an identifier of the performance is received by the receiving section 11 of the portable device 1 and is stored in the identifier storing section 12. On the other hand, record data of the performance held at the performance site 101 are supplied to the broadcast station 104 or the server 105, and in a state in which a corresponding identifier is attached thereto, the record data are received by the data receiving section 23 of the information processing device 2 via the broadcasting system 102 or the network 103. In the case where the identifier extracted from the received data matches the identifier of the identifier storing section 12, the identifier supplied from the identifier storing section 12 and record data supplied from the record data outputting section 26 that correspond to the identifier are stored in the data storing section 27.

In the case where the broadcasting system 102 is used, data are repetitively transmitted from the broadcast station 104 permanently or intermittently at night or the like. Therefore in this case, by connecting the portable device 1 with the information processing device 2, it is possible to make it unnecessary for the user to check the time when data are to be transmitted, and storage of record data can be automatically carried out.

On the other hand, in the case where the network 103 is used, for instance, data are received by so-called push-type information distribution, or by means of URL (Uniform Resource Locator) attached to an identifier, etc., in the case of the Internet. In the push-type information distribution, data distribution is carried out during night time, etc., when communication fees are discounted. In the case where the URL is attached to an identifier, complete record data can be obtained by accessing the URL when the portable device 1 is connected with the information processing device 2. Therefore, in the case where the network 103 is used, by connecting the portable device 1 with the information processing device 2, it is possible to make it unnecessary for the user to check the time when data are to be transmitted, and storage of record data can automatically be carried out.

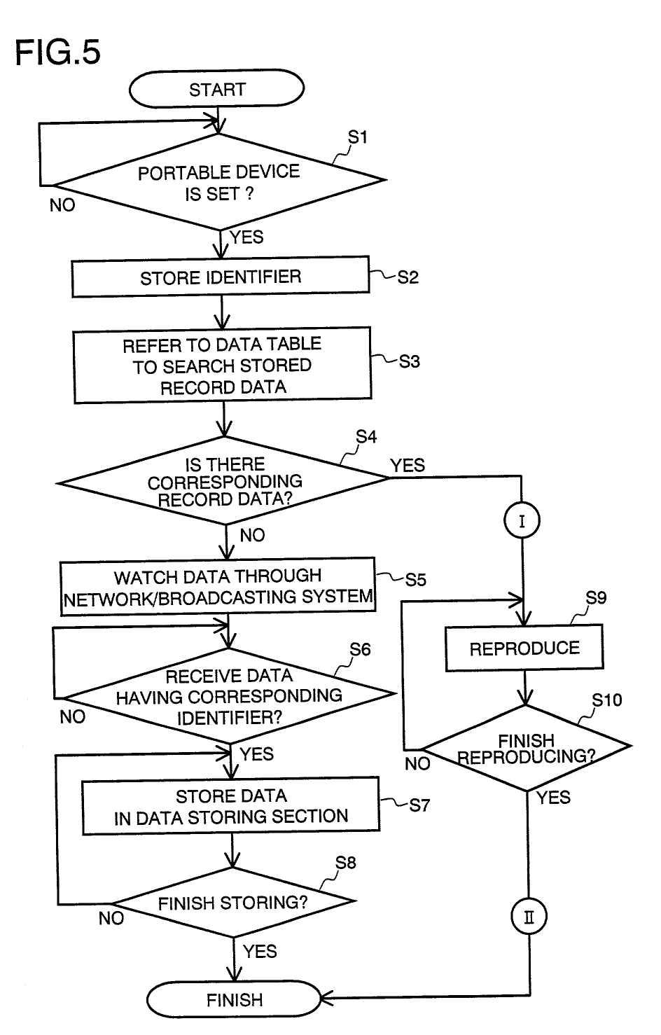

If the user carries the portable device 1 home or the like where the information processing device 2 is provided and connects the portable device 1 with the information processing device 2, the information processing device 2 carries out an operation of recording data of the performance that the user has watched, in a procedure shown in a flowchart of FIG. 5. The following will explain the procedure in detail.

First of all, the information processing device 2 supervises whether or not the portable device 1 is loaded (S1). Upon loading of the portable device 1, an identifier transmitted from the transmitting section 13 of the portable device 1 is received by the identifier receiving section 21 and stored in the identifier storing section 22 (S2).

On the other hand, with reference to a table in the data storing section 27 that stores record data main bodies and identifiers corresponding to the record data, together with respective correspondences therebetween (S3), whether or not record data corresponding to the identifier read from the identifier storing section 22 have been already stored is checked by the identifier comparing section 25 (S4). In the case where the corresponding record data are not stored, data transmitted from the broadcasting system 102 or the network 103 are supervised by the identifier comparing section 25 (S5).

Then, whether or not identifiers contained in the foregoing data are identifiers corresponding to the target record data is continuously checked using the identifier stored in the identifier storing section 22, and whether or not the target data are received is determined (S6). In the case where the target data are received, an identifier of the same and the identifier supplied from the identifier storing section 22 match each other. Therefore, it is confirmed that the record data of a performance of the identifier are the target record data, and the main body of the record data is stored in the data storing section 27 (S7). This operation is repetitively continued until all the corresponding record data are stored (S8).

On the other hand, at step S4, in the case where the target data of the identifier are already stored, the record data stored in the data storing section 27 are reproduced and displayed on, for instance, the reproducing section 28 (S9). Reproduction is continued until all the record data are reproduced (S10).

As described above, a performance recording system in accordance with the present embodiment is arranged so that an identifier of a performance that the user watches at a performance site 101 should be stored in the portable device 1, and that in the case where the identifier that the user has brought back matches an identifier attached to record data of a performance transmitted through the broadcasting system 102 or the network 103, the record data corresponding to the identifier should be reproduced.

Therefore, the user need not be engaged in recording to keep an accurate record of the performance at the performance site 101, but is allowed to fully enjoy the performance. Moreover, the user can keep vivid memories by the record data obtained through the broadcasting system 102 or the network 103. Furthermore, images and sounds obtained as record data are not limited to those at the user's position as is the case where images and sounds are recorded by the user him/herself at the performance site 101; they are images and sounds captured at various positions in the performance site 101, like in TV broadcasts. Further, there is not such an inconvenience that an entirety of the performance cannot be recorded due to limited broadcasting time like in TV broadcasts. In addition, it is unnecessary to consciously preselect and program the recording of a TV program, and the performance contents can accurately and easily be recorded.

[Second Embodiment]

The following will describe another embodiment in accordance with the present invention with reference to FIGS. 5 through 10. Note that, in the present embodiment, components having the same functions as with the First Embodiment will be given the same reference numerals, and explanation thereof will be omitted.

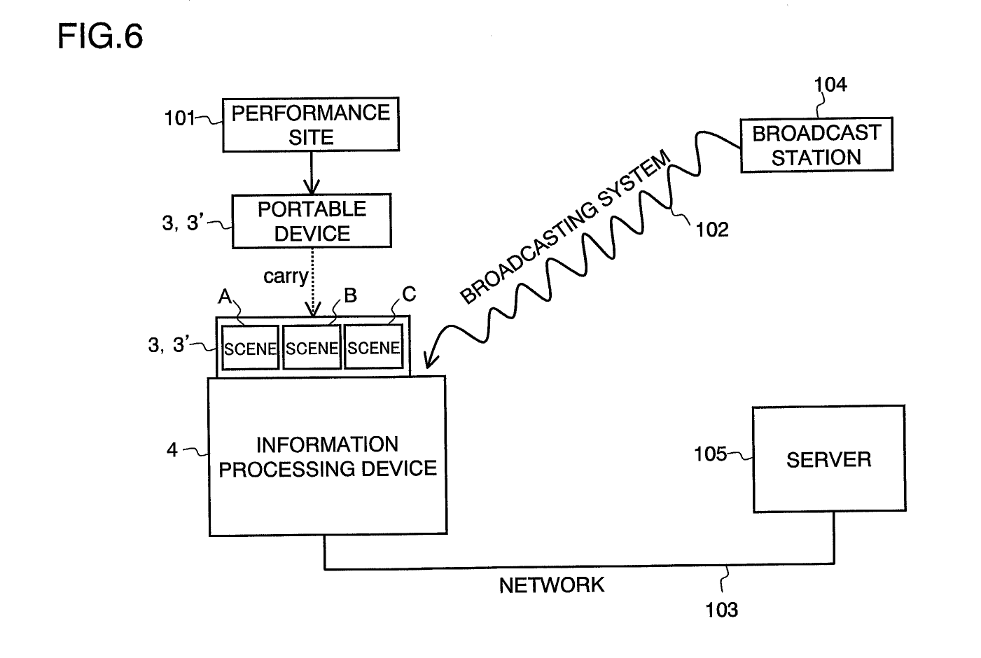

As shown in FIG. 6, a performance recording system according to the present embodiment includes, as substantially same as the performance recording system of the First Embodiment, a portable device 3, an information processing device 4, a performance site 101, and a broadcasting system 102 or network 103, provided the portable device 3 and the information processing device 4 have arrangements different from those of the portable device 1 and the information processing device 2.

A remarkable difference in performance recording systems of the present embodiment and the First Embodiment is that, as shown in FIG. 6, the portable device 3 displays images of finest scenes such as scenes A to C. These are snapshots of, for example, a famous scene from a theatrical performance and a portrait of a baseball player, that give a user a strong impression of the performance. By selecting these snapshots later, the user can locate the start of a sequence of record data such as a desired scene and reproduce it.

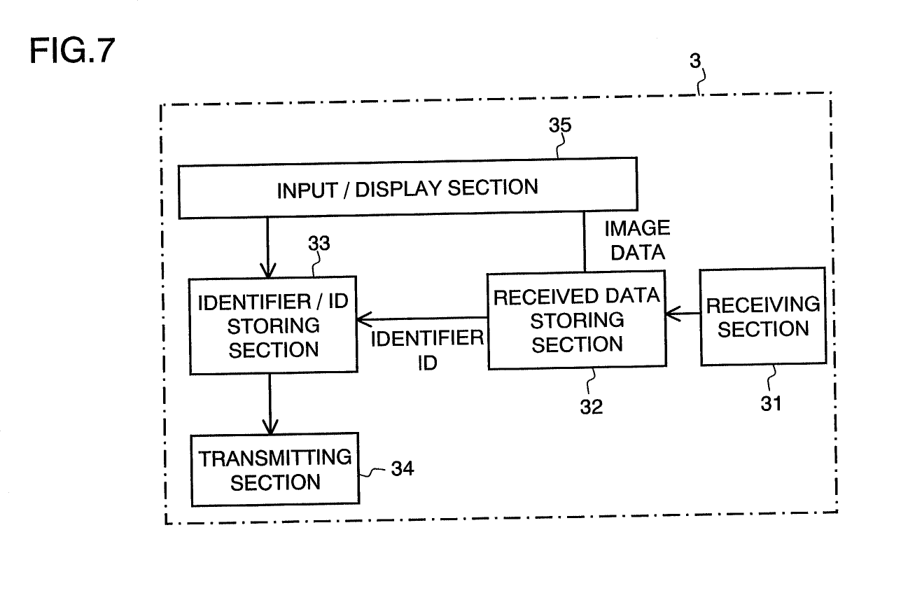

As shown in FIG. 7, the portable device 3 includes a receiving section 31, a received data storing section 32, an identifier/ID storing section 33, a transmitting section 34, and an input/display section 35.

The receiving section 31 has a receiving function as with the receiving section 11 of the performance recording system according to the First Embodiment.

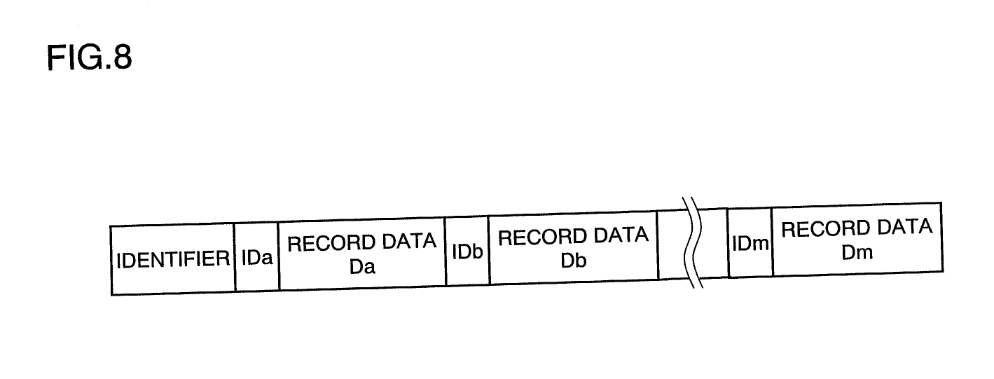

The received data storing section 32 is made up of a semiconductor memory such as a RAM, and other storage element and storage device so as to store received data which was received by the receiving section 31. The received data includes an identifier for individually identifying performances, images (partial data) representing the respective snapshots (for example, scenes A, B and C in FIG. 6), and an ID (partial data identifier) for individually identifying the snapshots of a single performance. In addition, the snapshots are not necessarily be represented by the images, and icon data may be adopted, instead. As shown in FIG. 8, the ID is attached to the beginning of each scene. For example, an ID given to the scene A is shown as “IDa”, and an ID given to a scene B is shown as “IDb”, which are followed by record data shown as “Da” and “Db”, respectively.

The identifier/ID storing section 33 stores only the identifier and the ID of all the received data stored in the received data storing section 32. In order to store identifiers received by the receiving section 31, the identifier/ID storing section 33 is made up of a semiconductor memory such as a RAM and other storage elements and storage devices.

The transmitting section 34, as with the transmitting section 13 of the portable device 1 according to the First Embodiment, transmits the identifier and the ID stored in the identifier/ID storing section 32 to the information processing device 2 when connected thereto.

The input/display section 35 displays an image and the like corresponding to an ID which was read out of the received data storing section 32, while allowing an user to directly select an image of a desired scene, etc. Therefore, the input/display section 35 includes, for instance, a device such as a touch panel that can be operated to input on a display panel.

A user inputs an ID by a method of, for example, directly touching a snapshot or an icon inputted in the input/display section 35, or clicking by an input device such as a mouse, thereby allowing a user to omit a step of inputting numbers, etc., as an ID, and simplifying operation for input.

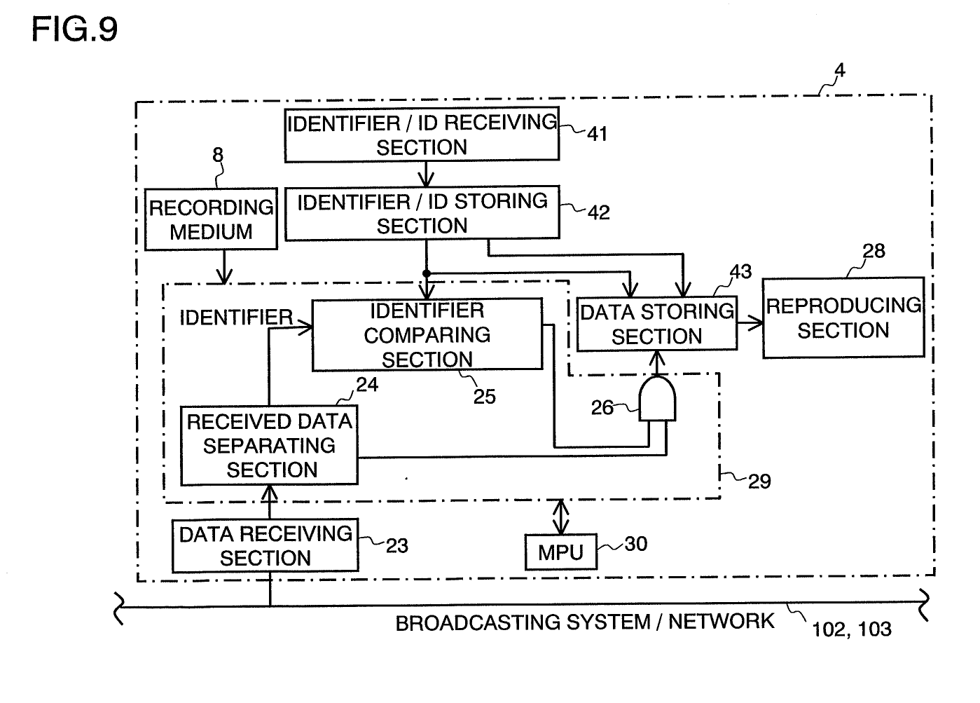

Further, the following will explain the information processing device 4 in detail. As shown in FIG. 9, the information processing device 4 includes an identifier/ID receiving section 41, an identifier/ID storing section 42, a data storing section 43, a data receiving section 23, a received data separating section 24, an identifier comparing section 25, a record data outputting section 26, and a reproducing section 28.

The identifier/ID receiving section 41 as accepting means receives an identifier and an ID read out of the identifier/ID storing section 32 of the portable device 3 and transmitted from the transmitting section 34, in a state where the portable device 3 ready to communicate is connected to the information processing device 4. In order to store the identifier and the ID received by the identifier/ID receiving section 41, the identifier/ID storing section 42 is made up of a semiconductor memory such as a RAM, and other storage element and storage device as with the identifier/ID storing section 33.

The data storing section 43 as storing means, as substantially same as the data storing section 27 of the information processing device 2, stores the identifier from the identifier/ID storing section 42 (corresponding to the identifier storing section 22) and a main body of the record data from the record data outputting section 26, both of which are arranged to correspond to each other in the form of a table. In addition, the data storing section 43 also stores the ID read out of the identifier/ID storing section 42 in the form of a table together with the identifier and the main body of the record data. Furthermore, when the ID is read out from the identifier/ID storing section 42 so as to be inputted, the data storing section 43 retrieves record data which corresponds to the ID from the table to the reproducing section 28.

In order to record a performance by utilizing the performance recording system thus arranged, first, a user should use the identifier/ID receiving section 31 of the portable device 3 so as to receive an identifier and an ID for a performance at a performance site 101, thereafter using the identifier/ID storing section 33 to store the identifier. Further, the user should input the ID through the input/display section 35, thereby displaying an image and the like representing each of the selectively inputted scenes on the input/display section 35.

Meanwhile, the record data of the performance carried out at the performance site 101 that have been given the corresponding identifiers are respectively received by the data receiving section 23 of the information processing device 4 via the broadcasting system 102 or the network 103. When an identifier extracted from the received data coincides with an identifier from the portable device 3, the identifier and the ID stored in the identifier/ID storing section 42 and record data corresponding to the identifier from the record data outputting section 26 are stored in the data storing section 43.

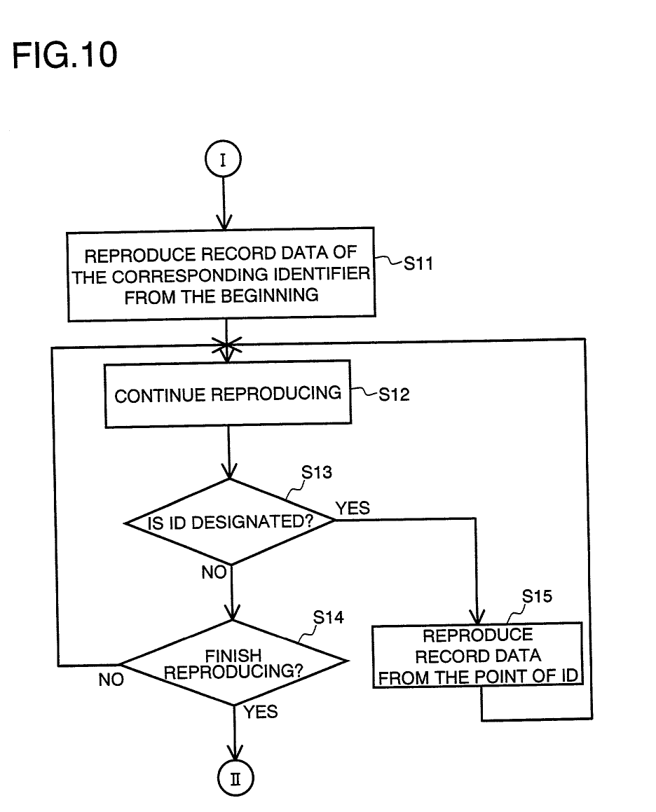

Further, when a user carries the portable device 3 back home, for example, where the information processing device 4 is provided, and connects the portable device 3 to the information processing device 4, the information processing device 4 carries out record processing of the data of the performance that the user watched through processes as shown in flowcharts of FIGS. 5 and 10. The following will explain the processes in detail.

As shown in FIG. 5, procedures from step S1 to step S8 are the same as those carried out by the information processing device 2 according to the First Embodiment; however, in the information processing device 4, steps S9 and S10 are replaced with the procedures of steps S11 through S15 (between I and II) shown in FIG. 10. In other words, the procedure to receive the desired record data via the broadcasting system 102 or the network 103 so as to store them is the same as the First Embodiment, and the procedure for reproduction is different. Accordingly, only the procedure for reproduction of the steps S11 through S15 will be explained here.

In the reproducing process, first, when the information processing device 4 has already stored the desired record data to be reproduced, at step S4 of FIG. 5 is selected YES, and the sequence goes to step S11 as shown in FIG. 10. At step S1, the record data of the corresponding identifier are reproduced from the beginning. The reproduction is continued until it finishes (S12).

During the reproduction, since it is likely that a user of the portable device 3 designates (selects) an ID of the scene via the input/display section 35, it is judged as to whether such designation (selection) was made (S13). For example, when the performance is a baseball game and the scenes A, B and C are respectively the second half of a first inning, the second half of a second inning, and the second half of a third inning, and when a user wishes to watch the second half of the third inning (scene C) before the second half of the first inning (scene A), an ID corresponding to the desired scene is designated. When an image of the desired scene is thus selected by the user, the ID is transmitted from the transmitting section 34 of the portable device 3 to the information processing device 4, thereafter, via the identifier/ID receiving section 41, storing the ID in the identifier/ID storing section 42.

When it is judged that no ID is designated at step S13, reproduction is continued until reproduction of all the record data finishes, and therefore, when record data to be further reproduced remain, the sequence goes back to step S12 so as to continue reproduction (S14). On the other hand, when it is judged that an ID is designated at step S13, the beginning of record data corresponding to the ID is found, and the record data are read out for reproduction (S15). By thus referring to an ID, the beginning of each scene can readily be found, thereby reproducing the scene.

Thus, in the performance recording system according to the present invention, it is arranged that the user's designation of an ID causes record data corresponding to the ID to be reproduced, thereby enabling the user to easily watch favorite scenes, etc. Further, by carrying back the portable device 3 that stores not only an identifier for a performance but also images of finest scenes in the performance and IDs respectively corresponding to the finest scenes, it is possible to utilize the images of the finest scenes as indexes in the partial reproduction of accurate record data in storage.

[Third Embodiment]

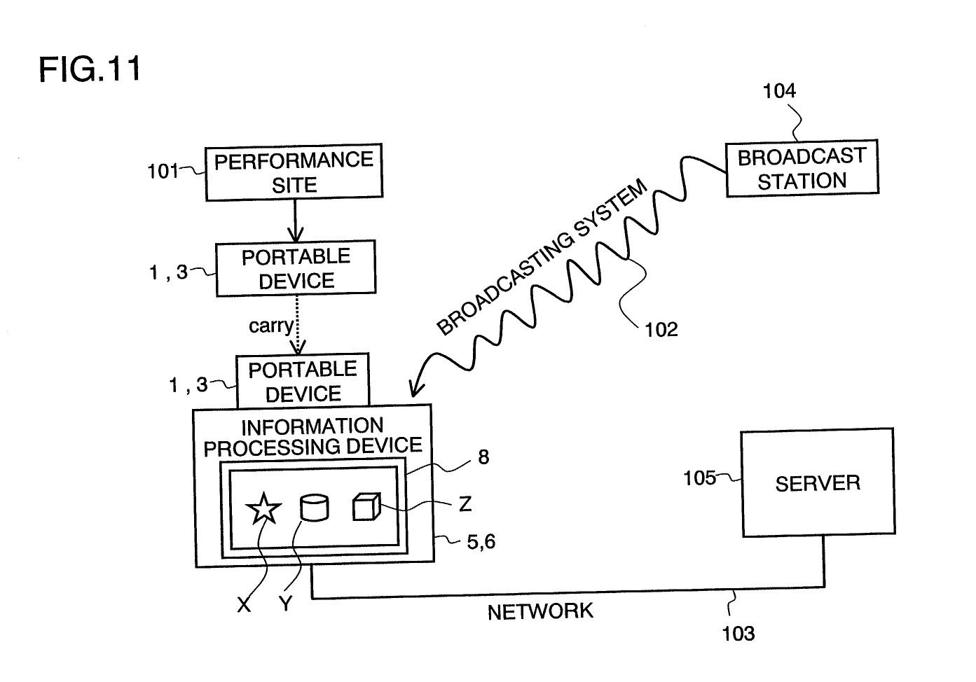

The following will describe still another embodiment according to the present invention with reference to FIGS. 11 through 13. Note that, in the present embodiment, components having the same function as with the First and Second Embodiments will be given the same reference numerals, and explanation thereof will be omitted.

As shown in FIG. 11, a performance recording system according to the present embodiment, as substantially same as the performance recording system of the First or Second Embodiment, includes a portable device 1 or 3, an information processing device 5 or 6, a broadcasting system 102 or a network 103, and a performance site 101; however, the information processing device 5 or 6 has an arrangement different from that of the information processing device 2 or 4.

In the First or Second Embodiment, explanation has been made through the case where the portable device 1 or 3 stores and reproduces record data in a state of being loaded in the information processing device 2 or 4, respectively. Namely, in order to allow the information processing device 2 or 4 to store or reproduce record data, the portable device 1 or 3 requires to be loaded into the information processing device 2 or 4, respectively.

In contrast, in the present performance recording system, the information processing device 5 or 6, as with the First or Second Embodiment, obtains an identifier only or a combination of an identifier and an ID from the portable device 1 or 3; however, here, icons corresponding to the identifier and/or the ID are displayed by a reproducing section 28 (display means) of the information processing device 5 or 6. By thus arranging that a user sets the icons to be ready for selection at anytime, that is, ready to become active, the record data can be stored and reproduced in the information processing device 5 or 6 even when having no portable device 1 or 3 loaded therein.

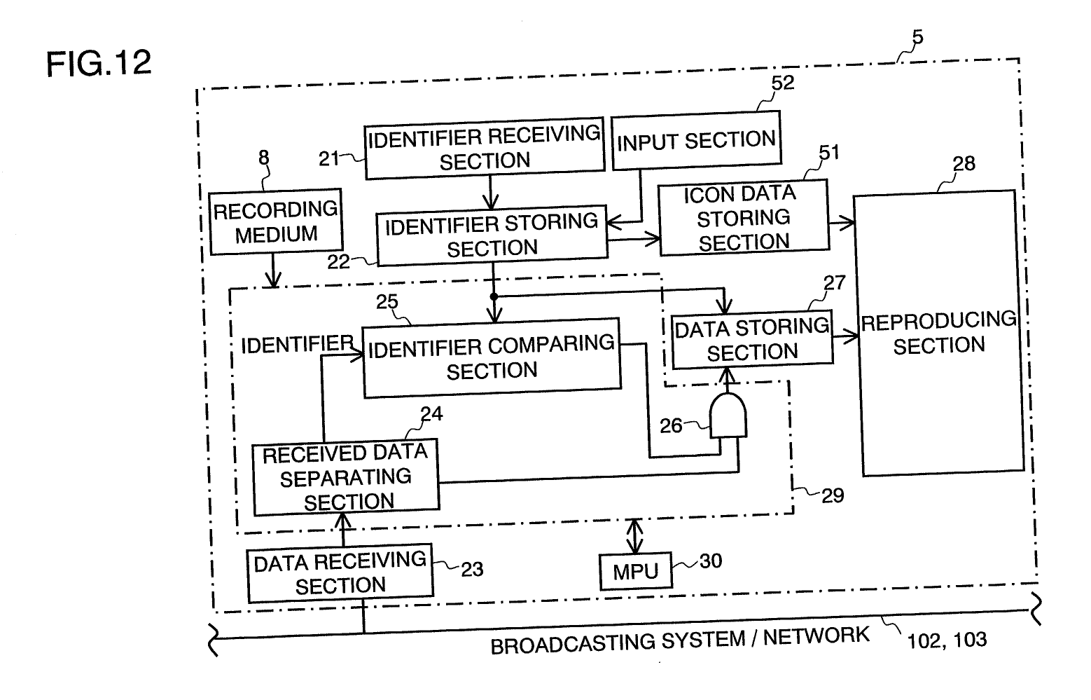

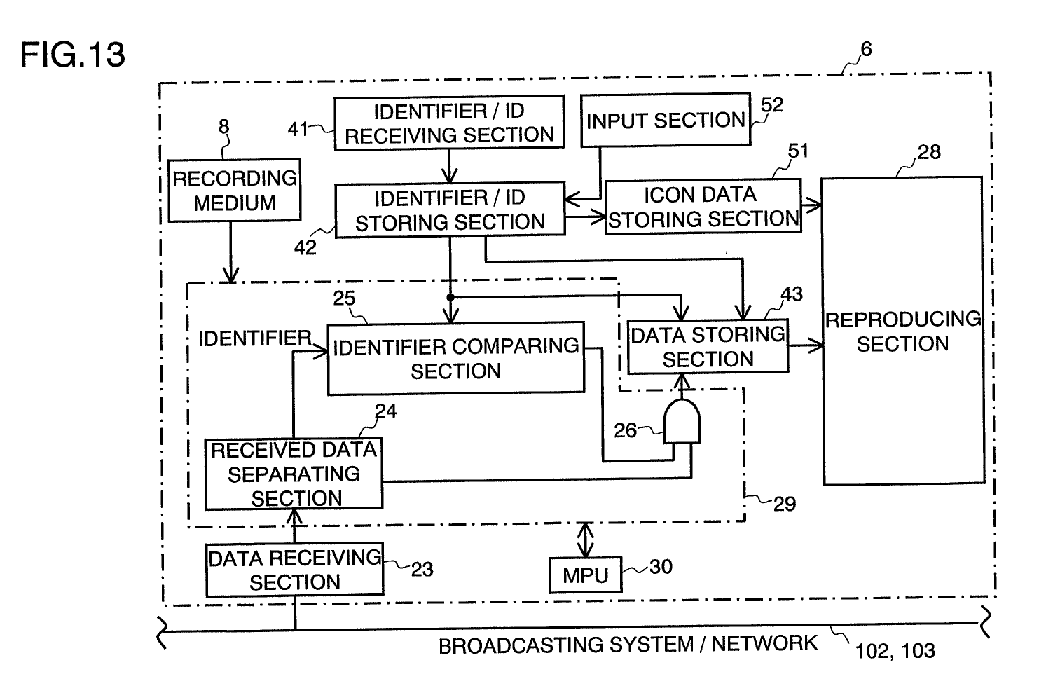

An information processing device 5 as shown in FIG. 12, in the information processing device 2 of the First Embodiment, is arranged such that icons corresponding to an identifier are displayed and selected, thereby storing and reproducing record data. On the other hand, As information processing device 6 as shown in FIG. 13, in the information processing device 4 of the Second Embodiment, is arranged such that icons corresponding to IDs are displayed and selected, thereby storing and reproducing record data.

As shown in FIG. 12, the information processing device 5 has an arrangement in which an icon data storing section 51 and an input section 52 are added to the information processing device 2 of the First Embodiment. On the other hand, as shown in FIG. 13, the information processing device 6 has an arrangement in which an icon data storing section 51 and an input section 52 are added to the information processing device 4 of the Second Embodiment.

The icon data storing section 51 is made up of a semiconductor memory such as a RAM and other storage elements and storage devices so as to store icon data which correspond to an identifier (in the case of the information processing device 5) or an ID (in the case of the information processing device 6) stored in the identifier storing section 22 or the identifier/ID storing section 42, respectively. In the icon data storing section 51 are prepared in advance icon data for allowing a user to separately identify an identifier or an ID, and results of a process in which the user utilized the input section 52 so as to cause identifiers or IDs to correspond to the icons are stored in the state of a table. Further, the icon data storing section 51 is set to read out the icons respectively corresponding to the identifiers or the IDs to the reproducing section 28 so as to display them by a display section of the reproducing section 28.

As to the icons, the following will show examples of the correspondence of the icons and the identifiers or the IDs: as shown in FIG. 11, an icon X having the shape of a star is set to correspond to an identifier “a”; an icon Y having the shape of a cylinder is set to correspond to an identifier “b”; and an icon Z having the shape of a cube is set to correspond to an identifier “c”. In addition, as an alternative form of icon, only characters such as “a” and “b” may simply be displayed.

Note that, in the foregoing example, the icons that the information processing device 5 has previously stored locally are used; however, the use of icons is not limited to this, and it is also possible that icons previously set to correspond to identifiers are received through the portable device 1 so as to store them in the icon data storing section 51.

The input section 52 as input means, in order to designate icons displayed by the display section of the reproducing section 28, has a device such as a touch panel which can be operated to input on a display surface of the display section. The input section 52 is set to input an icon which has been designated by a user who performed touch-input on the display surface to the identifier storing section 22 or the identifier/ID storing section 42 at touch-input coordinates. The identifier storing section 22 or the identifier/ID storing section 42 reads out an identifier only or a combination of an identifier and an ID corresponding to the designated icon to the identifier comparing section 25 and the data storing section 27 or 43 based on information of the coordinates of the designated icon.

In the performance recording system having the information processing device 5 or 6 thus arranged, when a user carries back the portable device 1 or 3 so as to load it into the information processing device 5 or 6, respectively, identifiers are transmitted from the portable device 1 to the information processing device 5, or identifiers and IDs are transmitted from the portable device 3 to the information processing device 6. Thereafter, it is not necessary that the portable device 1 or 3 is continuously loaded in the information processing device 5 or 6, respectively, until storage or reproduction of record data finishes.

Instead, the reproducing section 28 of the information processing device 5 or 6 displays icons which have been set to correspond to the received identifiers or IDs so as to enable a user to separately identify the identifier or the ID. In addition, by allowing the user to select the icons, the information processing device 5 or 6 can store and/or reproduce record data corresponding to the icons.

For example, in the information processing device 5, identifiers received through the identifier receiving section 21 are temporarily stored in the identifier storing section 22, thereafter reading icons which correspond to the identifiers out of the icon data storing section 51 and displaying them in the reproducing section 28. In that case, for example, if representative images of different scenes are displayed as icons, it is clear to a user, at a glance, what icon corresponds to each part of record data.

Further, when a user selects through the input section 52 an icon which corresponds to the desired record data of all the icons displayed in the reproducing section 28, an identifier corresponding to the icon is read out of the identifier storing section 22. This causes the desired record data that are separated by the received data separating section 24 to be stored in the data storing section 27 together with the identifier, thereby reproducing the desired record data in the reproducing section 28.

Meanwhile, in the information processing device 6, instead of the identifier employed in the information processing device 5, an ID received through the identifier/ID receiving section 41 and stored in the identifier/ID storing section 42 is set to correspond to an icon. Further, as a result of selection of icons in the input section 52, the ID corresponding to the icon and an identifier which is paired with the ID are read out so as to be utilized in the storage and/or reproduction of record data as above.

The storage and reproduction of the record data are conducted through the same procedures explained in the First and Second Embodiments.

As discussed, the performance recording system according to the present embodiment has an arrangement in which an identifier or an ID is set to correspond to an icon, thereafter displaying the icon in the reproducing section 28 so as to enable a user to select it, thereby storing or reproducing record data based on an identifier or an ID corresponding to the selected icon. Accordingly, a user is only required to select an icon corresponding to the received identifier or ID so as to reproduce record data corresponding to the icon. Consequently, unlike the performance recording system according to the First or Second Embodiment, it is not necessary to continuously load the portable device 1 or 3 in the information processing device 5 or 6, respectively.

[Fourth Embodiment]

The following will describe yet another embodiment according to the present invention with reference to FIGS. 1, 2, 6 and 14. Note that, in the present embodiment, components having the same function as with the First and Second Embodiments will be given the same reference numerals, and explanation thereof will be omitted.

A performance recording system according to the present embodiment, as with the performance recording system of the First Embodiment as shown in FIG. 1, includes a portable device 1, provided that the portable device 1 has a different arrangement. More specifically, in the portable device 1, an identifier storing section 12 does not store an identifier with respect to a performance received at a performance site 101 but has stored the identifier beforehand.

This enables an omission of a receiving section 11 for inputting an identifier at a performance site 101. Moreover, it is possible to utilize the portable device 1 as an entrance ticket (an admission ticket for performance) which is issued only once for each performance. By thus utilizing the portable device 1 as an entrance ticket, where the portable device is arranged to have the shape of, for example, a card, the manufacturing cost of the portable device 1 can be reduced. Besides, it is possible to obtain the portable device 1 as an entrance ticket for entering the performance site 101, and therefore it is no longer necessary to purchase the portable device 1 capable of a common use in different performances that is, however, infrequently used usually.

Consequently, the time consuming operation of storing an identifier in the portable device 1 at a performance site 101 is no longer necessary, and an identifier can be brought back in the same manner as an ordinary entrance ticket. Moreover, reduction in the cost of the portable device 1 results in an easier use of the performance recording system.

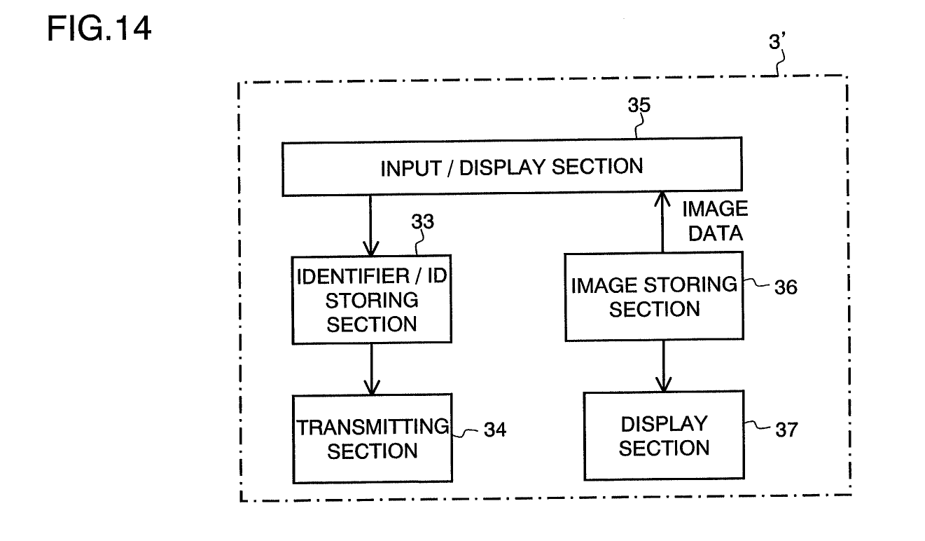

As shown in FIG. 6, another performance recording system according to the present embodiment includes a portable device 3′. As shown in FIG. 14, the portable device 3′ has, as with the portable device 3 shown in FIG. 7, an identifier/ID storing section 33, a transmitting section 34 and an input/display section 35, and further has an image storing section 36 and a display section 37. In addition, the identifier/ID storing section 33 in the portable device 3′, as with the aforementioned identifier storing section 12, previously stores an identifier and also the ID.

The image storing section 36 as information storing means is made up of a ROM and the like and previously stores an image corresponding to partial data which are related to a performance. Examples of the image include a snapshot of each scene of a performance. For example, when a musical is staged at a performance site 101, desirable is a snapshot representing each scene of the musical, such as a previously videotaped image of a famous scene from a first act, an image of a famous scene from a second act, and so on.

The display section 37 as reproducing means has a flat display such as a liquid crystal display device and a circuit for controlling display thereof. The display section 37 like this is mainly used for confirming an image, and therefore it is not required to have a high image quality, yet it is required to have a simple arrangement so as to be mounted in a compact portable device 3′.

In the portable device 3′ having the foregoing arrangement, since the identifier/ID storing section 33 stores identifiers and IDs, the receiving section 31 can be omitted. Further, by storing images related to a performance in the image storing section 36, the portable device 3′ itself can be a memento which reminds a user of his/her memories of the performance, and a physical key in the accurate reproducing of a record of the performance. This gives the portable device 3′ a higher additional value than a simple entrance ticket.

Note that, in the case of producing the portable device 1 or 3′ as an entrance ticket which can strictly be used only once, an elaboration of a surface thereof with a beautiful design allows it to be a superior memento which is a more effective reminder of memories. Further, producing the portable device 3′ so that a display surface of the display section 37 has the form of a small photograph stand and the like can greatly enhance a dramatic effect for the memories.

As a way to utilize the foregoing portable devices 1 and 3′, these may be used separately in accordance with an admission fee of a performance. For example, with respect to a performance requiring a relatively high rate of an admission fee may be used an entrance ticket in the fashion of the portable device 3′, whereas an entrance ticket in the fashion of the portable device 1 may be used with respect to a performance requiring a relatively low rate of an admission fee. Alternatively, there may be the case where the portable devices 1 and 3′ are used as entrance tickets for a single performance, provided that, for example, an entrance ticket in the fashion of the portable device 3′ is offered to an expensive seat such as a box, and an entrance ticket in the fashion of the portable device 1 is offered to a reasonable seat such as a reservation-free seat.

Note that, in the present embodiment, explanation has been made through a case in which, as with the portable device 3′, an image corresponding to partial data is previously stored. The data thus stored beforehand may include text data and sound data (music data) in addition to image data, provided that it is necessary, when storing sound data, to prepare a storing section capable of storing sound data in lieu of the image storing section 36, and a reproducing device (a device including a speaker, a reproducing circuit and the like) for reproducing sound data in lieu of the display section 37.

In the case of text data, data of an outline or program of a theatrical performance and the like can be stored, and in the case of sound data, it is possible to store a melodic phrase played in a concert, for example.

In the case where the input/display section 35 includes the function of the display section 37, the display section 37 can be omitted.

As discussed, the performance recording system according to the First Embodiment includes receiving means for receiving data distributed via a distribution medium, comparing means for making a comparison between a data identifier included in the data received by the receiving means and an identifier inputted from the outside, and storing means for storing data including the data identifier when the both data identifiers coincide with each other.

With this arrangement, selecting data which correspond to the inputted data identifier from the distributed data and storing the data enable a user to record data with regard to a performance which is specified by a data identifier corresponding to the performance that the user actually watched at a performance site. When the data is the record data of performance contents in the forms of a motion picture, a freeze-frame picture, sound and the like, the user can watch the performance as well as leave the performance contents as the record. Consequently, it is possible not only to enjoy an actual performance without being troubled by recording operation and also to readily obtain the accurate record of the performance contents.

The foregoing data recording device preferably has accepting means for accepting from a portable device capable of storing data identifiers and communicating data with the data recording device, the data identifiers as those inputted from the outside. By thus inputting the data identifier stored in the portable device to the data recording device via the accepting means, the user can input the data identifier to the data recording device by loading the portable device that stored the data identifier at the performance site into the data recording device, thereby readily inputting the data identifier to the data recording device.

Further, it is preferred that this arrangement includes data reproducing means for reproducing data which are read out of the storing means, wherein when referring to data stored in the storing means and detecting data corresponding to the data identifier from the accepting means, the comparing means reads data out of the storing means to the data reproducing means when the data corresponds to the data identifier from the accepting means; on the other hand, when the data are not yet stored in the storing means, the comparing means compares a data identifier included in the received data with a data identifier from the portable device. The results of the comparison shows the corresponding data identifier, and the storing means stores data having the corresponding data identifier.

With this arrangement, when a data identifier is inputted from the portable device to the data storing device, in the data storing device, the comparing means refers to data corresponding to the data identifier, and when, as a result, it detects the stored data corresponding to the data identifier, the data is read out of the storing means and reproduced by the data reproducing means. On the other hand, when, as a result of referring data, no data corresponding to the data identifier are stored, then the comparing means compares the data identifiers, and the storing means stores data having the corresponding data identifier according to results of the comparison.

By thus having the data reproducing means, the recorded data are read out of the storing means so as to be reproduced. However, when having no data, the storing means automatically selects the desired data and store them, thus simplifying operation that should be performed by a user for reproducing and storing, thereby improving operability.

With this arrangement, as with the Second Embodiment, it is preferable that a data identifier to be accepted by the accepting means includes a partial data identifier for identifying partial data included in the data, and the storing means reads out the corresponding partial data to the data reproducing means when the partial data identifier is accepted. The partial data include, for example, freeze-frame pictures or motion pictures capturing scenes from a performance. More specifically, when the plot of a theatrical performance is known, a freeze-frame picture or motion picture of the beginning of each scene is preferable, while in the case of plotless performances such as a baseball game, a freeze-frame picture, motion picture or the like of each baseball player participating in the game is preferable. The partial data are given a partial data identifier such as a spare ID. By thus using the partial data identifier as a data identifier, the desired partial data selected by a user can be reproduced, thereby readily reproducing data such as a scene of a performance which a user desires to watch.

Alternatively, the foregoing arrangement having a portable device, as with the Third Embodiment, preferably includes data reproducing means for reproducing data read out of the storing means, display means for displaying an icon corresponding to a data identifier received by the accepting means, and input means for selectively inputting the icon displayed by the display means, wherein when referring to data stored in the storing means and detecting stored data having a data identifier corresponding to the icon inputted by the input means, the comparing means reads data out of the storing means to the data reproducing means.

With this arrangement, the display means displays an icon corresponding to the data identifier from the portable device that the accepting means accepted in the data recording device. When the input means selectively inputs a desired icon among all the displayed icons, the comparing means confirms the presence of data having a data identifier corresponding to the inputted icon, thereafter reading the data out of the storing means, thereby reproducing the data by the data reproducing means.

By thus having the data reproducing means, the recorded data are read out of the storing means for reproduction. In addition, since an icon is used to select data to be reproduced, it is not necessary to keep the data recording device and the portable device ready to communicate with each other so as to input a data identifier to the data recording device, thus simplifying operation that a user should perform for reproducing and storing, thereby improving operability.

With this arrangement, it is preferable that a data identifier to be accepted by the accepting means includes a partial data identifier for identifying partial data included in the data, and the comparing means, when referring to data stored in the storing means and detecting partial data including the partial data identifier corresponding to an icon inputted by the input means, reads the partial data out of the storing means to the data reproducing means. By thus using the partial data identifier as a data identifier, the desired partial data corresponding to the icon can be reproduced, thereby readily reproducing scenes from a performance that a user desired to watch.

The performance recording systems according to the respective embodiments include a portable device which can be taken on the road and is used to obtain and store a data identifier given to a performance at a performance site, a distribution medium for distributing record data of the performance together with the data identifier as data, and each of the foregoing data recording devices for storing record data based on the data identifier from the portable device and the data identifier from the distribution medium.

A program for use in the performance recording systems of the respective embodiments performs (i) the process of comparing a data identifier included in the data received through the distribution medium with a data identifier inputted from the outside, and (ii) the process of storing data having the corresponding data identifier when the two identifiers coincide with each other.

In the data recording to be performed with this program, as with the data recording in the data recording device, selecting and storing data corresponding to a data identifier from the distributed data enable data recording of a performance specified by the data identifier corresponding to the performance that the user actually watched at a performance site, thereby allowing a user to actually watch the performance while recording performance contents according to the storing process.

The foregoing program preferably performs, with reference to the stored data, the process of reading out and reproducing data when the data corresponds to a data identifier inputted from the outside and is already stored, or the process of storing data having the corresponding data identifier when the data is not yet stored, by comparing the two data identifiers. With this program, as with the foregoing data recording device, the stored data is read out for reproduction. However, when no data are stored, the desired data are automatically selected and stored, thus simplifying operation that a user should perform for reproducing and recording, thereby improving operability.

Further, either of the foregoing programs may be recorded in a computer-readable recording medium.

The entrance ticket for performance according to the Fourth Embodiment is used as the portable device in the foregoing performance recording systems and includes data identifier storing means for previously storing the data identifier instead of obtaining it at the performance site.

In this arrangement, unlike the portable device adopted in the foregoing performance recording system that obtains a data identifier at a performance site, the data identifier is previously stored in the data identifier storing means of an entrance ticket for performance which is used as the portable device. Therefore, means to input a data identifier at a performance site can be omitted. In addition, this entrance ticket for performance can be used as an entrance ticket which is issued only once for each performance. By thus utilizing the portable device as an entrance ticket, where the portable device is arranged to have the shape of a card for example, the manufacturing cost for the portable device can greatly be reduced. Besides, it is possible to obtain the portable device as an entrance ticket for entering a performance site. This prevents an unnecessary purchase of the portable device capable of a common use in different performances that is, however, infrequently used usually.

The foregoing entrance ticket for performance preferably has information storing means for previously storing information corresponding to partial data included in the data, and reproducing means for reproducing information stored in the information storing means.

With this arrangement, the reproducing means reproduces information such as image data stored in the information storing means. Therefore, by thus storing an image related to a performance, the entrance ticket for performance itself becomes a memento to remind a user of his/her memories of the performance, and a physical key in the accurate reproducing of a record of the performance.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A data recording device, comprising:
receiving means for receiving data distributed through a distribution medium;
comparing means for making a comparison between a data identifier included in the data received by the receiving means and a data identifier inputted from the outside; and
storing means for storing data having the data identifier when the two data identifiers coincide with each other.

2. The data recording medium as set forth in claim 1, further comprising:
accepting means for accepting from a portable device which stores a data identifier and is set to be ready to communicate data with the data recording device, the data identifier as the data identifier inputted from the outside.

3. The data recording device as set forth in claim 2, further comprising:
data reproducing means for reproducing data which are read out of the storing means,
wherein when referring to data stored in the storing means and detecting stored data corresponding to the data identifier from the accepting means, the comparing means reads the data out of the storing means to the data reproducing means, and when the data are not yet stored in the storing means, the comparing means compares a data identifier which is included in the data received by the receiving means with a data identifier from the portable device, and
the storing means stores data having the corresponding data identifier according to results of the comparison.

4. The data recording medium as set forth in claim 3, wherein:
a data identifier to be accepted by the accepting means includes a partial data identifier for identifying partial data included in the data, and
the storing means reads out the corresponding partial data to the data reproducing means when the partial data identifier is accepted.

5. The data recording device as set forth in claim 2, further comprising:
data reproducing means for reproducing data read out of the storing means;
display means for displaying an icon which corresponds to the data identifier accepted by the accepting means; and
input means for selectively inputting the icon displayed by the display means,
wherein when referring to data stored in the storing means and detecting stored data having a data identifier corresponding to the icon inputted by the input means, the comparing means reads the data out of the storing means to the data reproducing means.

6. The data recording means as set forth in claim 5, wherein:
a data identifier to be accepted by the accepting means includes a partial data identifier for identifying partial data included in the data, and
when referring to the data stored in the storing means and detecting stored partial data having a partial data identifier corresponding to the icon inputted by the input means, the comparing means reads the partial data out of the storing means to the data reproducing means.

7. A performance recording system, comprising:
a portable device which is superior in carryability and capable of obtaining and storing a data identifier given to a performance at a performance site;
a distribution medium for distributing record data of the performance as data together with the data identifier; and
a data recording device which stores record data based on the data identifier from the portable device and the data identifier from the distribution medium, the data recording device including:
(a) receiving means for receiving data distributed through the distribution medium;
(b) comparing means for making a comparison between a data identifier included in the data received by the receiving means and a data identifier inputted from the outside; and
(c) storing means for storing data having the data identifier when the two data identifiers coincide with each other.

8. The performance recording system as set forth in claim 7, wherein the data recording device includes accepting means for accepting from the portable device that stores a data identifier and is set to be ready to communicate data with the data recording device, the data identifier as the data identifier inputted from the outside.

9. The performance recording system as set forth in claim 8, wherein:
the data recording device has data reproducing means for reproducing data read out of the storing means,
when referring to data stored in the storing means and detecting stored data corresponding to a data identifier from the accepting means, the comparing means reads the data out of the storing means to the data reproducing means, and when the data is not yet stored in the storing means, the comparing means compares a data identifier included in the data received by the receiving means and a data identifier from the portable device, and
the storing means stores data having the corresponding data identifier according to results of the comparison.

10. The performance recording system as set forth in claim 9, wherein:
the data recording device has a data identifier which is to be accepted by the accepting means and includes a partial data identifier for identifying partial data included in the data, and
the storing means reads out the corresponding partial data to the data reproducing means when the partial data identifier is accepted.

11. The performance recording system as set forth in claim 8, in which the data recording device includes:
data reproducing means for reproducing data read out of the storing means;
display means for displaying an icon which corresponds to a data identifier accepted by the accepting means; and
input means for selectively inputting the icon displayed by the display means,
wherein when referring to data stored in the storing means and detecting stored data having a data identifier corresponding to the icon inputted by the input means, the comparing means reads the data out of the storing means to the data reproducing means.

12. The performance recording system as set forth in claim 11, wherein:
the data recording device has a data identifier which is to be accepted by the accepting means and includes a partial data identifier for identifying partial data included in the data, and
when referring to data stored in the storing means and detecting stored partial data having a partial data identifier corresponding to the icon inputted by the input means, the comparing means reads the partial data out of the storing means to the data reproducing means.

13. The performance recording system as set forth in claim 7, wherein the portable device is a mobile phone capable of receiving the data identifier which is transmitted by radio waves.

14. The performance recording system as set forth in claim 7, wherein the portable device is a card-type device to which an identifier is magnetically or electronically writable.

15. A data recording program for performing the processes of:
making a comparison between a data identifier included in data which are received through a distribution medium and a data identifier inputted from the outside; and
storing data having the data identifier when the two data identifiers coincide with each other.

16. The data recording program as set forth in claim 15, which performs the processes of:
reproducing data by reading it out when referring to stored data and detecting the data corresponding to the data identifier inputted from the outside; and
storing data having the corresponding data identifier according to a comparison made between the two data identifiers when the data is not yet stored.

17. A recording medium which stores a data recording program for performing the processes of:
making a comparison between a data identifier included in data which are received through a distribution medium and a data identifier inputted from the outside; and
storing data having the data identifier when the two data identifiers coincide with each other.

18. The recording medium as set forth in claim 17, which stores the data recording program for performing the processes of:
reproducing data by reading it out when referring to stored data and detecting the data corresponding to the data identifier inputted from the outside; and
storing data having the corresponding data identifier according to a comparison made between the two data identifiers when the data is not yet stored.

19. An entrance ticket for performance used as a portable device in a performance recording system, the performance recording system comprising:
the portable device which is superior in carryability and has data identifier storing means for previously storing a data identifier given to a performance;
a distribution medium for distributing record data of the performance as data together with the data identifier; and
a data recording device which stores record data based on the data identifier from the portable device and the data identifier from the distribution medium, the data recording device including:
(a) receiving means for receiving data distributed through the distribution medium;
(b) comparing means for making a comparison between a data identifier included in the data received by the receiving means and a data identifier inputted from the outside; and
(c) storing means for storing data having the data identifier when the two data identifiers coincide with each other.

20. The entrance ticket for performance as set forth in claim 19, wherein the data recording device of the performance recording system includes accepting means for accepting from the portable device that stores a data identifier and is set to be ready to communicate data with the data recording device, the data identifier as the data identifier inputted from the outside.

21. The entrance ticket for performance used in the performance recording system as set forth in claim 20, the performance recording system wherein:
the data recording device has data reproducing means for reproducing data read out of the storing means,
when referring to data stored in the storing means and detecting stored data corresponding to a data identifier from the accepting means, the comparing means reads the data out of the storing means to the data reproducing means, and when the data is not yet stored in the storing means, the comparing means compares a data identifier included in the data received by the receiving means and a data identifier from the portable device, and
the storing means stores data having the corresponding data identifier according to results of the comparison.

22. The entrance ticket for performance used in the performance recording system as set forth in claim 21, the performance recording system including:
the data recording device having a data identifier which is to be accepted by the accepting means and includes a partial data identifier for identifying partial data included in the data, and
the storing means for reading out the corresponding partial data to the data reproducing means when the partial data identifier is accepted.

23. The entrance ticket for performance used in the performance recording system as set forth in claim 19, the performance recording system including the data recording device which has:
data reproducing means for reproducing data read out of the storing means;
display means for displaying an icon which corresponds to a data identifier accepted by the accepting means; and
input means for selectively inputting the icon displayed by the display means,
wherein when referring to data stored in the storing means and detecting stored data having a data identifier corresponding to the icon inputted by the input means, the comparing means reads the data out of the storing means to the data reproducing means.

24. The entrance ticket for performance used in the performance recording system as set forth in claim 23, the performance recording system wherein:
the data recording device has a data identifier which is to be accepted by the accepting means and includes a partial data identifier for identifying partial data included in the data, and
when referring to data stored in the storing means and detecting stored partial data having a partial data identifier corresponding to the icon inputted by the input means, the comparing means reads the partial data out of the storing means to the data reproducing means.

25. The entrance ticket for performance as set forth in claim 19, including:
information storing means for previously storing information corresponding to partial data included in the data; and
reproducing means for reproducing the information stored in the information storing means.

26. The entrance ticket for performance as set forth in claim 25, wherein the data recording device of the performance recording system includes accepting means for accepting from the portable device that stores a data identifier and is set to be ready to communicate data with the data recording device, the data identifier as the data identifier inputted from the outside.

27. The entrance ticket for performance used in the performance recording system as set forth in claim 26, the performance recording system wherein:
the data recording device has data reproducing means for reproducing data read out of the storing means,
when referring to data stored in the storing means and detecting stored data corresponding to a data identifier from the accepting means, the comparing means reads the data out of the storing means to the data reproducing means, and when the data is not yet stored in the storing means, the comparing means compares a data identifier included in the data received by the receiving means and a data identifier from the portable device, and
the storing means stores data having the corresponding data identifier according to results of the comparison.

28. The entrance ticket for performance used in the performance recording system as set forth in claim 27, the performance recording system including:
the data recording device having a data identifier which is to be accepted by the accepting means and includes a partial data identifier for identifying partial data included in the data; and
the storing means for reading out the corresponding partial data to the data reproducing means when the partial data identifier is accepted.

29. The entrance ticket for performance used in the performance recording system as set forth in claim 25, the performance recording system including:
data reproducing means for reproducing data read out of the storing means;
display means for displaying an icon which corresponds to a data identifier accepted by the accepting means; and
input means for selectively inputting the icon displayed by the display means,
wherein when referring to data stored in the storing means and detecting stored data having a data identifier corresponding to the icon inputted by the input means, the comparing means reads the data out of the storing means to the data reproducing means.

30. The entrance ticket for performance used in the performance recording system as set forth in claim 29, the performance recording system wherein:
the data recording device has a data identifier which is to be accepted by the accepting means and includes a partial data identifier for identifying partial data included in the data, and
when referring to data stored in the storing means and detecting stored partial data having a partial data identifier corresponding to the icon inputted by the input means, the comparing means reads the partial data out of the storing means to the data reproducing means.
